(19) United States
(12) Patent Application Publication
(10) Pub. No.: US 2008/0033725 A1
(43) Pub. Date: Feb. 7, 2008

(54) METHODS AND A SYSTEM FOR PROVIDING DIGITAL MEDIA CONTENT

(75) Inventors: David Peak, Chicago, IL (US); Daniel Anderson, Rocklin, CA (US); Paul Hletko, Evanston, IL (US)

Correspondence Address: BELL, BOYD, & LLOYD LLP, P.O. BOX 1135, CHICAGO, IL, 60690, US

(73) Assignee: LIQUIDTALK, INC., Chicago, IL (US)

(21) Appl. No.: 11/782,296

(22) Filed: Jul. 24, 2007

Related U.S. Application Data
(60) Provisional application No. 60/820,182, filed on Jul. 24, 2006.

(51) Int. Cl. G10L 13/00; G06F 15/16

(52) U.S. Cl. 704/260; 709/231

(57) ABSTRACT

The present disclosure includes methods for providing digital media content. A method includes capturing content, receiving the captured content as a file, and determining a recipient of the received file. The received file is converted to a digital media file and automatically transmitted to the recipient. Another method includes providing a first content and a second content. The first content is automatically transmitted to a first recipient group, which includes multiple recipients. The second content is automatically transmitted to a second recipient group, which also includes multiple recipients.

### RELATED APPLICATIONS

This patent claims the benefit of U.S. Provisional Patent Application Ser. No. 60/820,182 filed Jul. 24, 2006, the entire disclosure of which is fully incorporated by reference herein.

### BACKGROUND

The present disclosure relates generally to methods for generating, editing, organizing, and distributing digital media content.

In today's mobile workforce, there is a need for on-the-go access to dynamic corporate knowledge, amongst other things. For example, sales representatives constantly need to keep abreast of product updates, sales planning, and HR compliance issues. Traditional means of gaining access to such corporate knowledge is through classroom and web-based learning, as well as periodic sales meetings. However, these forms of corporate knowledge transfer and communication pose significant opportunity costs as salespeople have to forgo important client calls in order to attend in-person meetings and classroom-based training. Moreover, the traditional methods of knowledge transfer are not suitable for on-the-go consumption by mobile workers who are often on the road and in the air. Alternatively, email does a poor job of imparting the tone and emphasis stressed by audio and visual communication. As a result, companies increasingly display an interest in providing sales representatives and other mobile employees with more convenient access to corporate knowledge via digital media players. At the same time, these companies realize the value of rapidly creating new content and making this information more accessible to their mobile workforces.

The use of digital media objects, such as audio (mp3, Podcasts™) and video (mp4, video Podcasts™) has increased tremendously by consumers for entertainment and informational use. Personal communications devices, such as portable digital media players, enable users to remotely transmit, store, and play these types of digital media content. For example, users are able to load television shows to a portable digital media player to watch during an airplane flight or on a train ride to work.

Typically a user downloads digital media files through the Internet to the user's computer. A utility program can then be used to download the digital media files to the user's portable digital media player.

A Podcast™ is an example of a digital media file. Podcasts™ are typically used to share video and/or audio content regarding a particular subject or theme. Podcasts™ are usually distributed over the Internet. A Podcast™ can be organized into episodes much like a radio or television program. A user can subscribe to receive Podcast™ episodes that are subsequently published. Typically, if a new Podcast™ episode is available, it is downloaded to the user's computer. Thereafter, the user can play the Podcast™ episode at their computer in the same manner as other media files. A utility program can be used to download the Podcast™ episode to the user's portable digital media player.

### SUMMARY

In one embodiment of the invention, there is a method for providing digital media content, including receiving captured content as a file; determining a recipient for the received file; converting the captured content into a digital media file, such that the digital media file is in a format accessible by the recipient; and automatically transmitting the digital media file to the recipient.

In another embodiment of the invention, there is a method for providing digital media content, including providing a first content and a second content; converting the first content into a first file format, and the second content into a second file format; automatically transmitting the first content to a first recipient group wherein the first recipient group includes a plurality of recipients using the first file format; and automatically transmitting the second content to a second recipient group wherein the second recipient group includes a plurality of recipients using the second file format.

In still another embodiment of the invention, there is a system for automatically sending digital media content, including a first content and a second content, each received as a first file and a second file; a first recipient group determined by the first file content and second recipient group determined by the second file content, wherein the first recipient group and the second recipient group include a plurality of recipients; and a first digital media file converted from the first file and a second digital media file converted from the second file, wherein the first digital media file is automatically transmitted to the first recipient group and the second digital media file is automatically transmitted to the second recipient group.

In one aspect of the invention, the system and method provide an application for integrating or communicating with Learning Management Systems (LMS's) and Learning Content Management Systems (LCMS's) to extend corporate learning to a handheld device, such as a digital media player, in addition to existing learning approaches, such as web and paper based systems.

Additional features and advantages are described herein, and will be apparent from, the following Detailed Description and the Figures.

### BRIEF DESCRIPTION OF THE FIGURES

FIG. 1 is a diagram illustrating an embodiment of the present disclosure of a system for providing digital media content.

FIG. 2A is a diagram illustrating an embodiment of the present disclosure for providing digital media content.

FIG. 2B is a diagram further illustrating an embodiment of the present disclosure as shown in FIG. 2A for providing digital media content.

FIG. 3 is a flowchart illustrating an embodiment of the present disclosure of a method for providing digital media content.

FIG. 4 is a flowchart illustrating an embodiment of the present disclosure of a method for providing digital media content.

FIG. 5 is a flowchart illustrating an embodiment of the present disclosure of a method for providing digital media content.

FIG. 6 is a flowchart illustrating an embodiment of the present disclosure of a method for providing digital media content.

FIG. 7 is a flowchart illustrating an embodiment of the present disclosure of a method for providing digital media content.

FIG. 8 is a flowchart illustrating an embodiment of the present disclosure of a method for providing digital media content.

FIG. 9 is a flowchart illustrating an embodiment of the present disclosure of a method for providing digital media content.

### DETAILED DESCRIPTION

The present disclosure relates generally to methods for generating, editing, organizing, and distributing digital media content. In this regard, the system and method allows for digital media content to be pushed to users, such as employees, to drive the on-demand learning of mobile users. In turn, this enables users to access and distribute content for learning. This content, for example audio, video, flash, etc., can be downloaded to media players and the like, and content on a user's media player becomes a “learning appliance” that can be used anywhere at anytime.

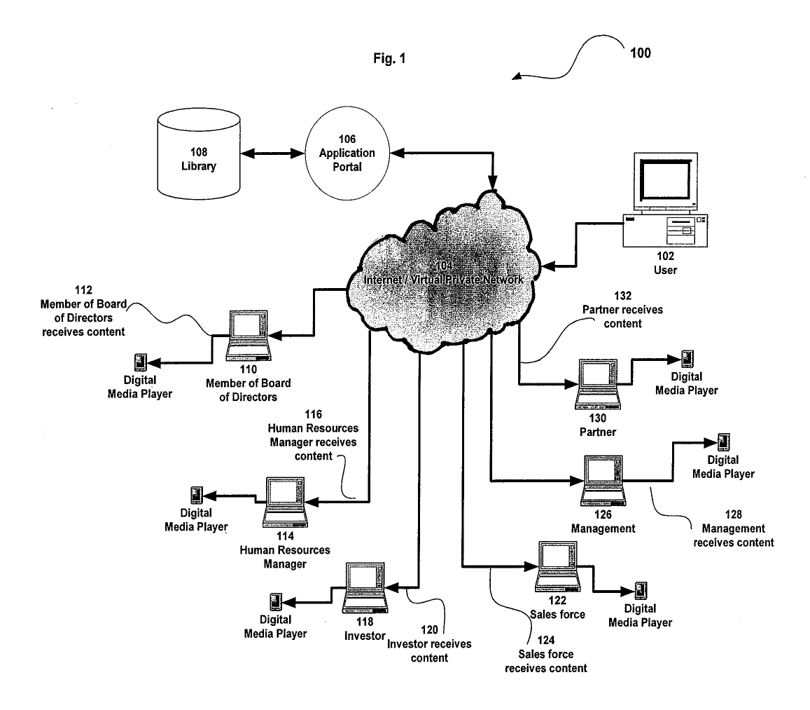

Turning to FIG. 1, a diagram illustrating a system 100 for providing digital media content is shown. A user 102 logs onto a server used for storing content as digital media files, sometimes referred to as a library 108 or repository server, through an application portal 106. This portal may be a secure portal. The portal 106 may include interactive web pages for the user 102 to navigate and upload content and digital media files. A user 102 may access the portal 106 either through the Internet or a Virtual Private Network 104. Alternatively, the library 108 and portal 106 may be accessed through an intranet.

More specifically, the library 108 stores data, such as employee profiles, which include information on each employee work roles, learning objectives, and approved access to content. Of course, the data is not limited to these examples, but could relate to any type of information for storage. The library, as briefly identified, may be accessed through a secure web address or installed behind a firewall and delivered through an intranet. Of course, it may also be accessed through a public system, such as the Internet. Using a secure portal, for example, users 102 may access, manage and disseminate corporate knowledge and learning. Accessing the library 108 through the Internet or intranet 104, users 102 may select to have content and related information delivered, for example, daily, weekly or monthly, or search the content to locate a specific request.

Users 102 access and interact with the system 100 through their portal 106 over the internet 104 or the intranet. Users 102 are also recipients, for example a member of the board of directors 110, a human resources manager 114, an investor 118, a member of the sales force 122, a manager 126, or a partner 130. The preceding types of recipients are merely exemplary in nature; the types of recipients will vary depending on the organization utilizing the system 100. Users 102 can access their digital media files and can consume those digital media files using a portable digital media player or, a web-enabled computer or the like.

Users 102 can, among other things, create, approve, publish and manage digital content: 1) create-users can create content by triggering workflows with production partners, such as video and audio projects, use automated workflows to convert existing digital files to digital media, or self-author content using features or third party tools of the system; 2) approve-content created or converted can be reviewed and approved by authorized users to ensure applicability and quality; 3) publish-after review, content can be published or surfaced to the appropriate individuals, team, workgroup, etc.; and 4) manage-meta data and supporting information can be assigned to content so that it can be categorized and queried efficiently; and content can be pulled or posted to a customer application. The users account settings will determine the types of activities they may engage in.

There may be various classes of users. Users access and drive interaction with the system through a portal account over the Internet or intranet. For example, some users may be designated approvers, who can review content submitted for their approval, approve content for distribution, and determine the scope for distributing that content. Other users may be instructors who can access learning objects from a Learning Management System (LMS) in the library 108 and set digital media files for automatic transmission to recipients. Another possible class of user is an administrator who conducts maintenance tasks on the user accounts. Another possible class of user is a production partner. Production partners may receive production requests from an authorized user and deliver output from those requests to recipients.

An individual within an organization utilizing the system 100 may also have multiple user settings. For example, a member of the board of directors 110 may be a general user, an approver, and a production partner. Management 126 may be both an approver and an instructor, whereas a member of the sales force 122 may only be a general user, or merely a recipient of digital media files. Each type of member of an organization may receive content, 112, 116, 120, 124, 128, 132, uploaded by a user 102. Thus, a user 102 may tag content for various types of distribution. For example, some content for automatic transmission may be designated for investors only, some for board members, or perhaps organization-wide announcement to all members.

The present disclosure includes such a system for automatically sending content, as noted above. A component of the system, referred to as a translator, enables content conversion of data into a format suitable for digital media players. For example, a user can create audio casts by calling a dedicated toll free phone number or submitting a text document for conversion. These audio and text files are converted into a digital media format, when necessary, for storage in the library 108. As an example, a first content and a second content, each received as a first file and a second file, respectively, where the first and second files are in different formats, such as text and html files. A first recipient group is determined by the first file content, and second recipient group is determined by the second file content. Specifically, the first group consists of text format users, and the second group consists of html format users. The first recipient group and the second recipient group may include individual or a plurality of recipients. A first digital media file is created by converting the first file, and a second digital media file is created by converting the second file. The first digital media file is stored in the library and automatically transmitted to the first recipient group, such as the board of directors, and the second digital media file is stored in the library and automatically transmitted to the second recipient group, such as the sales force. It should be understood that although the example above uses two different contents and files, any number of contents and files may be used.

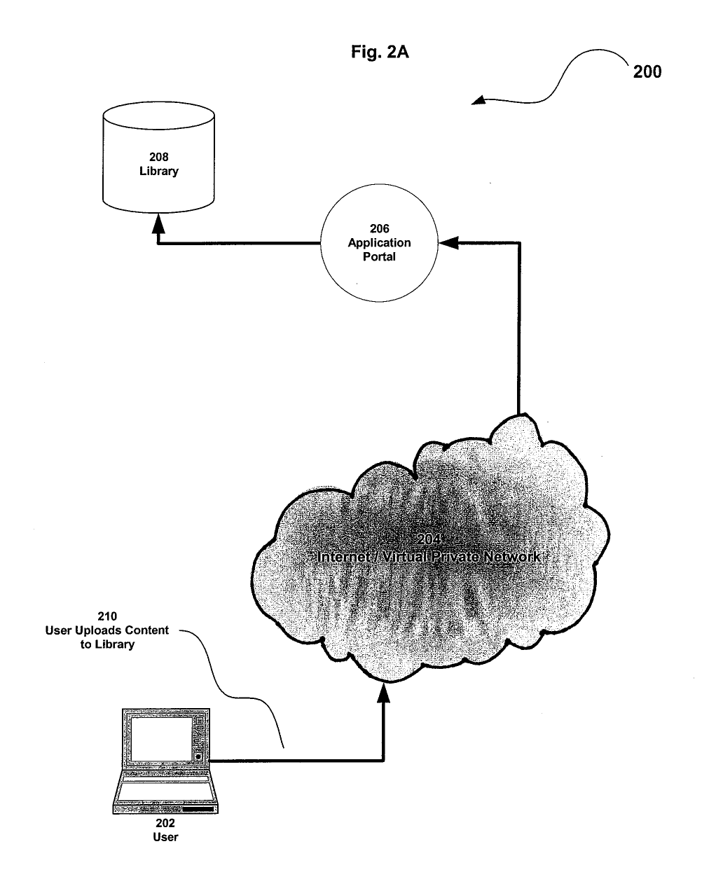

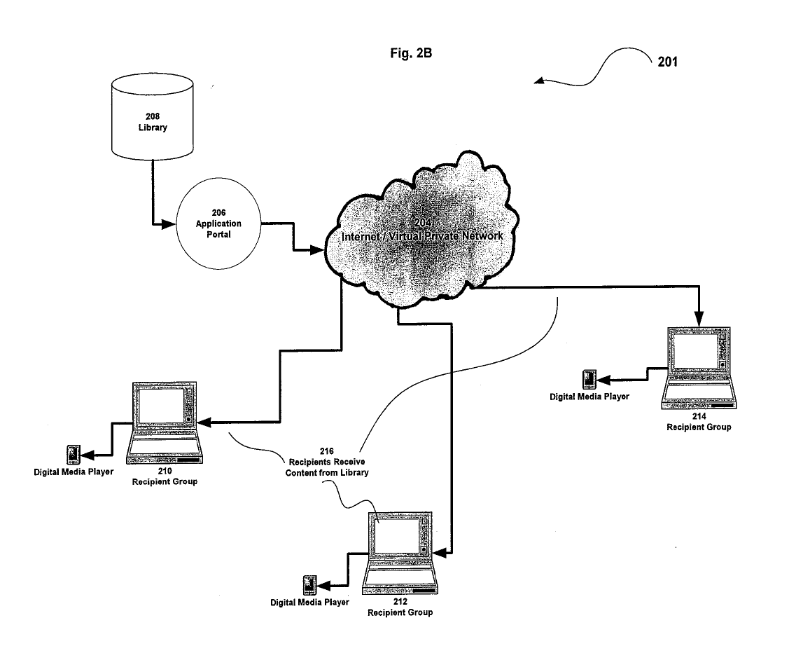

Turning to FIGS. 2A and 2B, diagrams illustrating an embodiment for providing digital media content of the present disclosure are shown. The embodiment includes providing a first content and a second content, as discussed above. The first content is automatically transmitted to a first recipient group which includes multiple recipients. The second content is automatically transmitted to a second recipient group which also includes multiple recipients. The method may also include providing a third content and automatically transmitting the third content to both the first recipient group and the second recipient group. It is readily understood that any number of content and/or recipients may be designated.

Steps of the method shown as 200 (FIG. 2A) and 201 (FIG. 2B) illustrate the embodiment previously described. Step 100 (FIG. 1) of the method includes, for example, a user 202 uploading content 210 to a server used for storing content as digital media files, sometimes referred to as a library 208. The user 102 accesses the library 208 through, for example, an application portal 206. This portal may be a secure portal. The portal may also include interactive web pages for the user 102 to navigate and upload content and digital media files. A user 102 may access the portal 206 either through the Internet or a Virtual Private Network 204. Alternatively, the library 108 and portal 106 may be accessed through an intranet.

Step 201 of the method includes various recipient groups 210, 212, and 214. Although each group is represented by a single computer and digital media player, it should be understood that the recipients within each group may have individual computers, digital media players, etc. After content is uploaded, as described and illustrated with respect to FIG. 2A, the content is automatically transmitted to the recipient groups 210, 212, and 214, as designated by each group's profile. Typically, the recipient groups 210, 212, and 214 may receive content from the library 216 during a synchronization operation of the recipient's digital media player, or may be automatically updated upon receipt of the information. In this manner, a first content uploaded from a user 202 may be automatically transmitted to a first recipient group, such as 210 and 212. A second content uploaded from a user 202 may be automatically transmitted to a second recipient group, 214. Additionally, a third content uploaded by a user 202 may be automatically transmitted to the first and second recipient groups, 210, 212, 214.

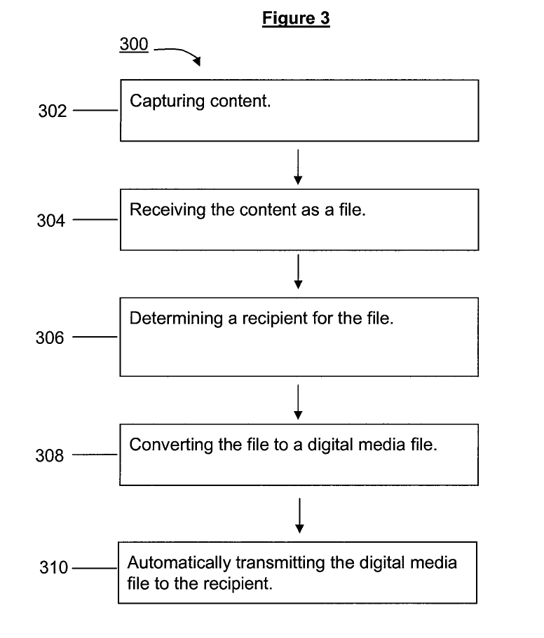

FIG. 3 is an embodiment of a method 300 for providing digital media content to a user. The method 300 includes capturing content 302. Content may be captured, for example, by creating a video recording, creating an audio recording, creating an image, or creating a text version of the content. After the content is captured, the content is received as a file at step 304.

At step 306, the system determines a recipient for the file 306, and the file is converted to a digital media file 308. Digital media files may include audio, video, images, or combinations thereof. For example, a digital media file may play audio only, video only, images only, both audio and video, or it may include a sequence of images coupled with audio. The MP4 format is an example of a file format that can play both audio and video. More examples of digital media file formats also include AVI, MPEG such as MPEG-1 and MPEG-2 (both PAL and NTSC types), ASF, DVD, VCD, Audio CD, MP3, 3GP, MOV, WMV, WMA, DVR-MS, WAV, AU, SND, AIFF, 3GP, MPEG 4, DVR-MS, DV-AVI, MIDI, REALMEDIA and QuickTime.

Other examples of digital media files include Podcasts™ which refer to audio and/or video files transmitted over the internet via syndication feeds including formats such as RSS or Atom. This is achieved by an individual using his or her computer to access a Podcast™ website that hosts the RSS feed. He may then subscribe to the RSS feed so that their computer occasionally re-visits the Podcast™ website to check for any new Podcast™ episodes.

The method 300 also includes a step of automatically transmitting the converted file to the recipient 310, such as transmitting the converted file to the recipient's portable digital media player. A portable digital media player is an umbrella term for a variety of devices small enough to carry that may play audio and/or video, display still images, or any combination thereof. For example, portable digital media players may include personal digital assistants (“PDA”), cellular phones, smart phones, and hand held gaming devices.

In another embodiment, content is automatically transmitted to a recipient when the recipient logs onto a server storing the digital media file, sometimes referred to as a library or repository server, through a portal. This portal may be a secure portal. The portal may include interactive web pages for the user to navigate and seek digital media files. A user may access the portal either through the Internet or an intranet. The server recognizes and authenticates the user's identity. Then, the server automatically transmits a digital media file to the user's computer. When the user's portable digital media player synchronizes with the user's computer, the transmitted digital file is automatically transmitted and stored on the user's portable digital media player for future consumption. An RSS feed may notify a user and distribute new content available on the secured server to the user.

Automatically transmitting the digital media file may include transmitting the digital media file to the recipient via a packet data network such as the Internet or an intranet. A repository server or library may be connected to the packet data network to facilitate transmission of the digital media file. Companies often employ an intranet within the company to more easily control, protect, and disseminate company information to its employees. The server housing the library and portal to access the stored digital media files may be located behind a company's firewall and be integrated into their intranet. Alternatively, the server may be accessible via the Internet or a Virtual Private Network.

In another embodiment, the method may include storing a recipient profile on the repository server. The recipient profile may then be associated with a digital media file stored on the repository server. The recipient profile may include items such as the recipient's name, job title, Podcast™ subscriptions, subject matter interests, synchronizing preferences (e.g. when to automatically transmit content to the recipient's computer), portal preferences, and other various elements of account information.

The method may also include receiving a rating of the digital media file from the recipient and storing the received rating. The recipient's profile may be updated to reflect any ratings given by the recipient. The ratings may be viewed by other users and used to evaluate digital media file content. Users may also refer content to other users or groups of users. These users can synchronize their portable digital media players with their computers to receive referred digital media files for future consumption. For example, a sales manager can refer content, such as a digital media file containing new product information, to her sales team.

The method may also include determining a metadata tag based on the captured content and associating the metadata tag with the captured content. Metadata may then be used to search for digital media files and to automatically transmit certain digital media files to recipients based on their profiles also containing metadata about the user. The method may also include receiving an approval notification and automatically transmitting the digital media file based on the approval notification.

In another embodiment, the method may include converting the received file to a digital media file by compressing the file using an audio compression algorithm. For example, the audio compression algorithm may include any of the following formats: MP3, OGG or Ogg Vorbis, WMA OR Windows Media Audio, AAC or Advanced Audio Coding, WAV or Waveform Audio Format, AIFF or Audio Interchange File Format, and REALAUDIO.

In another embodiment, the method may include converting the received file to a digital media file using a video/audio compression algorithm for files containing both audio and video. For example, the video/audio compression algorithm may include any of the following formats: MP4, AVI or audio video interleave, QuickTime, DivX, and REALMEDIA.

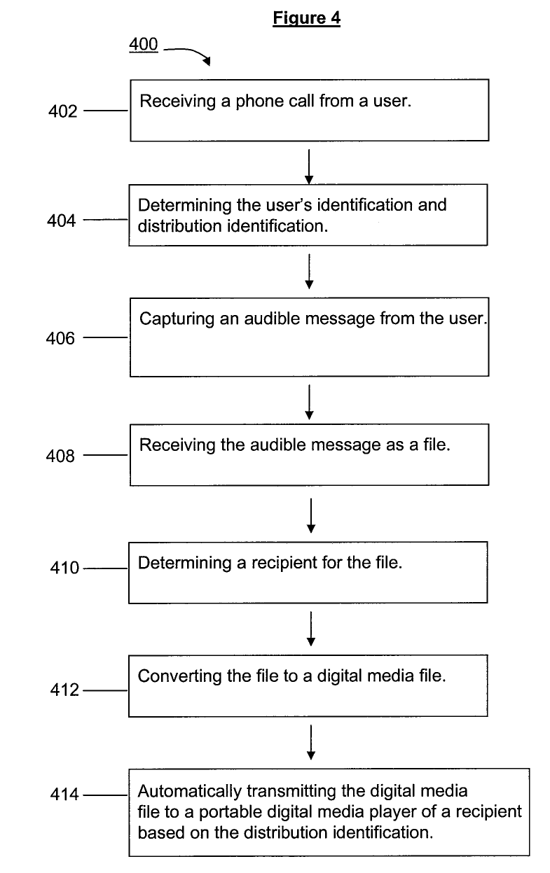

Turning to FIG. 4, a flowchart illustrating another embodiment of the present disclosure is shown. A method 400 includes receiving a phone call from a user 402 and determining the user's identification and distribution identification 404. Distribution identification may include identifying distribution lists that the user is a member of, or identifying distribution lists over which the user has administrative control, and thus can select digital media files to be automatically transmitted to members of those distribution lists.

The method also includes capturing an audible message from the user 406, and receiving the audible message as a file 408. Thus the method may include capturing a human voice as the content. The method also includes determining a recipient for the file 410, and converting the file to a digital media file 412. Interactive voice recognition may be used to tag the content to identify, for example, the file subject matter, or who should receive the file. The digital media file is then automatically transmitted to a recipient's portable digital media player based on the distribution identification 414. For example, a sales manager may need to have her sales team participate in a new mini-seminar about a new sales tactic, but the sales team is spread throughout the region. She may place a call and identify her title and the distribution lists she controls, and then present the mini-seminar describing the new sales tactic over the phone.

The audible message is then received as a file and converted to a digital media file. The recipients of the file, for example, her sales team, are determined. Metatags describing the preferred file format associated with each member of the sales team can then be used to convert the received file into the correct digital file format. The digital media file is then automatically transmitted to the sales team based on the distribution identification. Each member of the sales team may now consume the mini-seminar on their portable digital media player at a convenient time. The sales manager may also send an approval notification, thereby automatically transmitting the digital media file based on the approval notification.

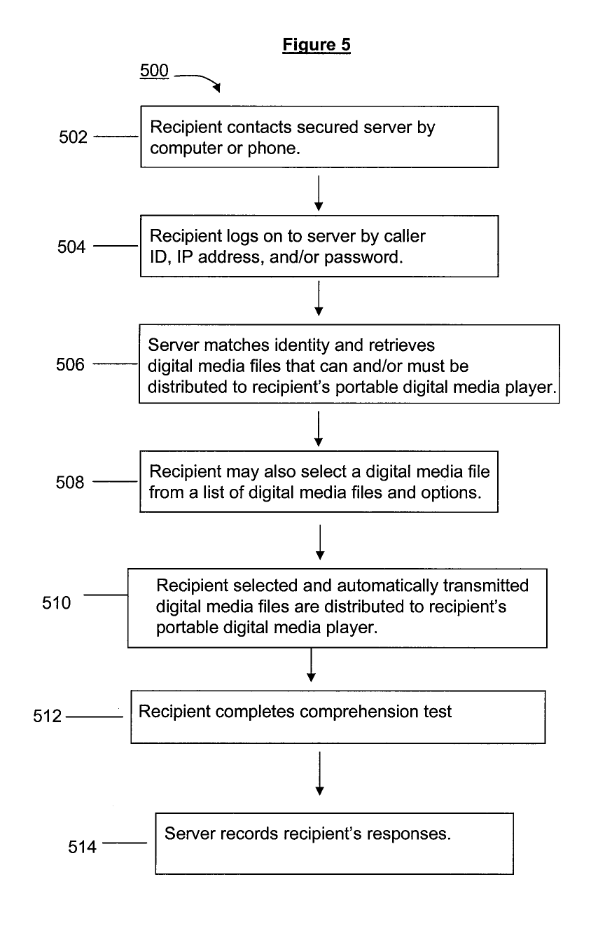

FIG. 5 is a flowchart illustrating another embodiment of the method 500 for providing multimedia content. A recipient contacts a secured server by computer or phone 502. The server may be the repository server housing the library or another server. The recipient logs on to the server such as by using caller ID, an IP address, and/or a password 504. The server matches identity of the recipient and retrieves digital media files that can and/or must be distributed to the recipient's portable digital media player 506.

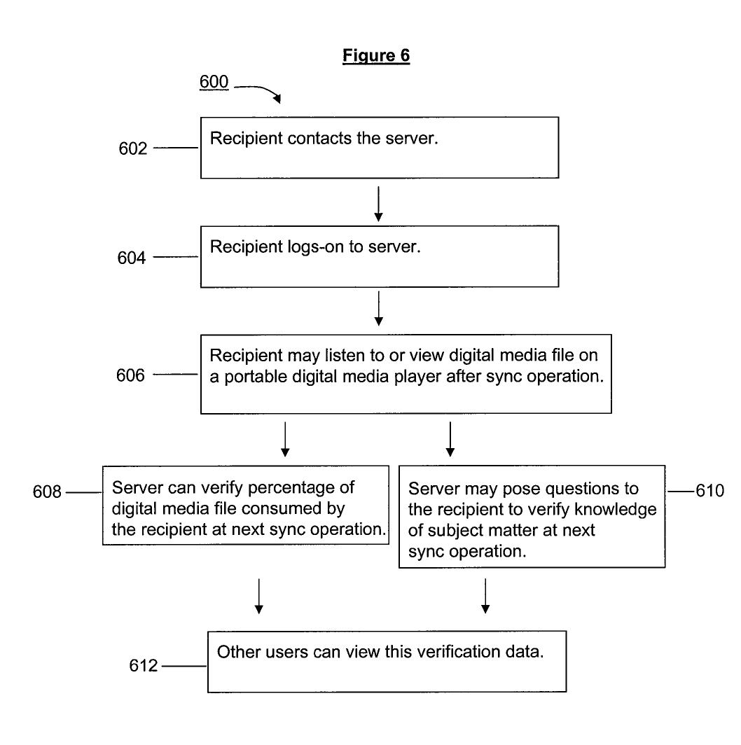

The recipient may also select digital media files from a list of files and options 508. The recipient-selected and automatically-transmitted digital media files are distributed to the recipient's portable digital media player when performing a sync operation 510. The recipient then completes a comprehension test 512 and the server records the recipient's responses 514. Thus, the method may include monitoring the recipient's consumption of the digital media file as will be shown in FIG. 6.

FIG. 6 is a flowchart illustrating another embodiment of the method 600 for providing multimedia content, including the step of monitoring the recipient's consumption. A recipient contacts the server 602 and logs on to the server 604. The server may be a repository server storing the library of digital media files. Next the recipient may listen to or view digital media files on a portable digital media player after a sync operation 606.

The method includes monitoring the recipient's consumption of the digital media file, which may be accomplished, for example, in the following two ways. After the next sync operation, the server can verify a percentage of the digital media file consumed by the recipient 608. Alternatively, the server may pose questions to the recipient to verify the recipient's knowledge of the digital media file content 610. Other users may then view the verification data 612, such as a sales manager verifying that a sales associate consumed new information about a forthcoming new product.

Monitoring a recipient's consumption of the digital media file may take place in various ways. For example, monitoring may include testing comprehension. Comprehension tests may include multiple choice questions, true/false questions, or short answer questions. The test may have a relative or absolute due date. Another example of monitoring may include reporting on a recipient's usage of a digital media file.

Reporting usage may include verifying whether all or only part of the digital media file was consumed, especially the automatically transmitted digital media files. If only part of the digital media file was consumed by the recipient, reporting may include what portion of the digital media file was consumed. For example, if the digital media file was divided into parts, the report could list which part was consumed. Or the report could merely list the portion of the digital media file consumed according to time markers, such as a consuming the portion starting at the three minute mark and ending at the five minute mark.

Monitoring consumption enables other users to assess the utility of a digital media file and the recipient's performance. For example, an instructor may desire to require recipients to take a test about a digital media file that contains information about a new product. By monitoring the recipients usage and comprehension of the digital media file, a feedback loop is created to help the instructor modify content as necessary or to assess employee progress.

Moreover, administrative users may not only monitor consumption but also create and maintain digital media files and determine how users can access and sync the digital media files. Administrative users may also create and maintain user accounts including end users, content/learning administrators, and system administrators. Additionally, administrative users may set up authorization levels to limit user access to digital media files. Administrative users may also schedule automatic transmissions to recipients of digital media files that are a part of a formal learning program, digital media files desired by the recipient that have content to augment learning, or digital media files for entertainment purposes.

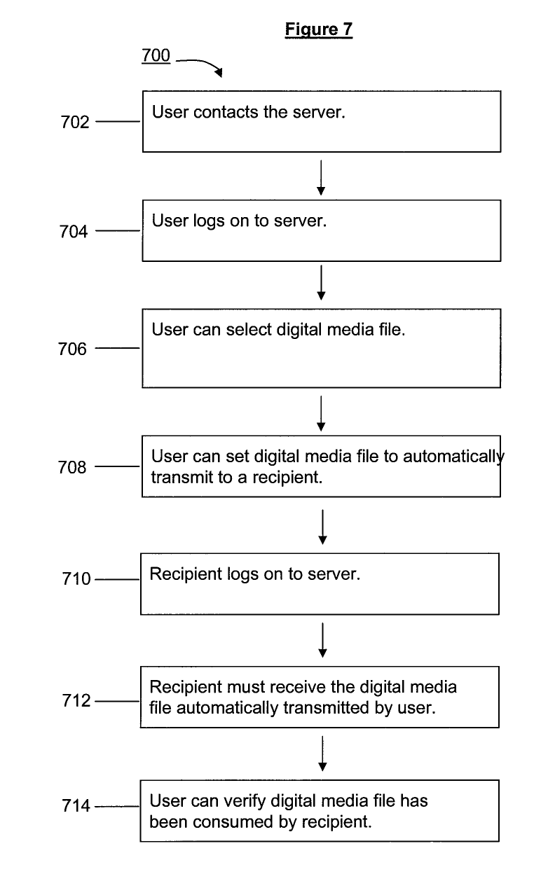

FIG. 7 is a flowchart illustrating another embodiment of the method 700 for providing multimedia content, illustrating some of the administrative functions previously discussed. A user contacts the server 702 and the user logs on to the server 704. The user can set a digital media file 706 to automatically transmit to a recipient 708. A recipient logs on to the server 710 and the recipient must receive the digital media file automatically transmitted by the first user 712. The digital media file may be automatically transmitted during a sync operation of the recipient's portable digital media player. Later, the user can verify the digital media file has been consumed by the recipient 714, such as by the monitoring methods previously disclosed.

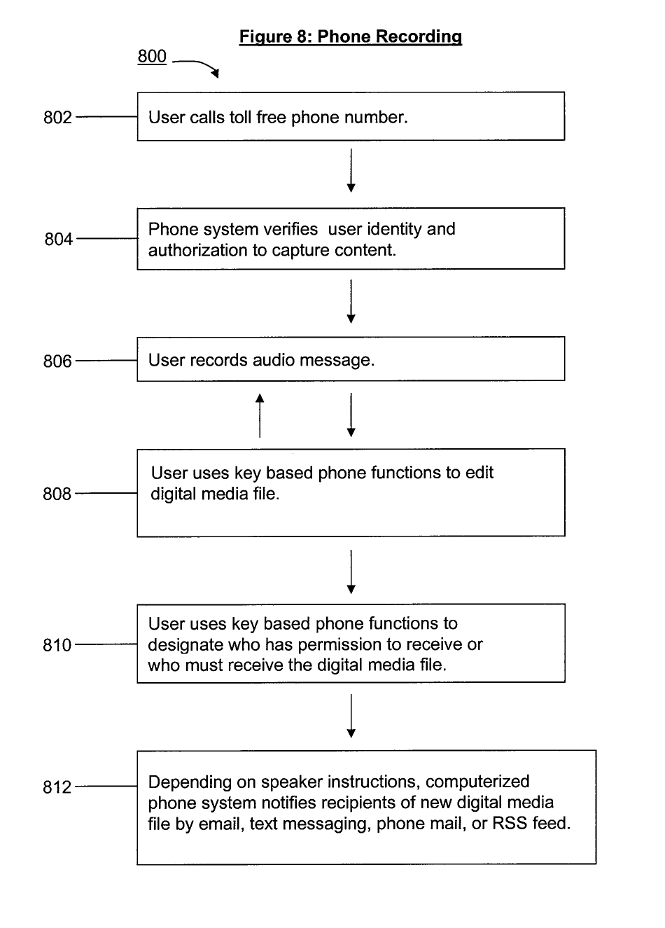

FIG. 8 is a flowchart illustrating another embodiment of the method 800 for providing multimedia content. A user calls a toll free number 802. The phone system verifies the user's identity and authorization to capture content 804. Authorization may occur through a caller ID and/or a key code such as a PIN number. The user then records an audio message 806, thereby capturing content and creating a digital media file. The user then uses key based phone functions to edit the digital media file 808. For example, the user could follow prompts to listen to the recorded digital media file or to erase portions of the digital media file. Next, the user uses key based phone functions to designate who has permission to receiver or who must receive the digital media file 810. Depending on the user's instructions, the computerized phone system notifies recipients of a new digital media file to be consumed by email, text messaging, phone mail, or RSS feed 812.

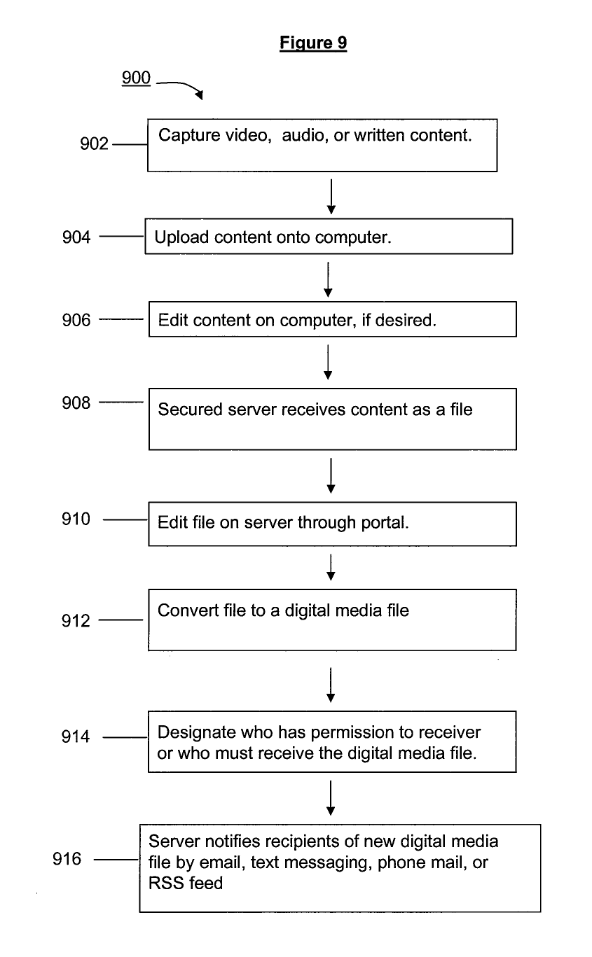

Turning now to FIG. 9, a flowchart illustrates another embodiment of the method 900 for providing multimedia content. Video, audio, or written content is captured 902. For example, a lecture could be recorded via video and audio or just audio. The lecture could have written materials scanned into a computer or could be taken from a computer text document already created. Next, the content is uploaded onto a computer 904, and edited on the computer if desired 906. After logging on to a secured server through a portal, the secured server receives the content as a file 908. The server may be a repository server used for storing a library of digital media files, organized and tagged using metadata tags, such as id3 tags.

The file may then be edited, including conversions and translations, on the server through a portal 910. Thus, the method may include parsing a received file with a text-to-speech converter. For example, a written document converted to an audio file of the written document. Additionally, the method may include determining a preferred language of the recipient and translating the received file into the preferred language prior to parsing the received file with a text-to-speech converter.

For example, a new product manual accompanying an item for sale, written in English, may be uploaded onto the computer. The secured server receives the file permitting the user to edit the file. During the editing step, a user may request that the item be distributed in an audio format for members of a distribution list to listen to. One of the members may not understand English. The metadata tag indicates the recipient's preferred language for audio files. The text version of the file will then be translated into the preferred language before parsing the file using a text to speech converter. Thus, each recipient may receive the digital media file in a preferred language.

After editing the file on the server through the portal 910, the file is converted to a digital media file 912. A user can then designate who has permission to receive a file or who must receive a digital media file 914, by automatically transmitting the file to a recipient. The server may then notify recipients of a new digital media file to be consumed by email, text messaging, phone mail, or RSS feed 916.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

We claim:

1. A method for providing digital media content, comprising:
receiving captured content as a file;
determining a recipient for the received file;
converting the captured content into a digital media file, such that the digital media file is in a format accessible by the recipient; and
automatically transmitting the digital media file to the recipient.

2. The method of claim 1, which includes monitoring consumption by the recipient of the digital media file.

3. The method of claim 1, which includes parsing the captured content with a text-to-speech converter.

4. The method of claim 3, which includes determining a preferred language of the recipient and translating the captured content into the preferred language before the captured content is parsed.

5. The method of claim 1, which includes distributing the digital media file using an RSS standard.

6. The method of claim 1, wherein converting the captured content to a digital media file includes compressing the file using an audio compression algorithm.

7. The method of claim 1, wherein converting the captured content to a digital media file includes compressing the file using a audio/video compression algorithm.

8. The method of claim 1, wherein the captured content includes a human voice.

9. The method of claim 1, which includes determining a metadata tag based on the captured content and associating the metadata tag with the captured content.

10. The method of claim 1, wherein automatically transmitting the digital media file includes transmitting the digital media file via a packet data network.

11. The method of claim 1, which includes storing the digital media file on a repository server connected to a packet data network.

12. The method of claim 12, which includes storing a recipient profile on the repository server, such that the captured content is converted into a format corresponding to a format designated in the profile.

13. The method of claim 13, which includes associating the recipient profile with the digital media file.

14. The method of claim 1, which includes receiving a rating of the digital media file from the recipient and storing the received rating.

15. The method of claim 15, which includes determining a metadata tag for the digital media file based on the received rating.

16. The method of claim 1, which includes receiving an approval notification and automatically transmitting the digital media file based on the approval notification.

17. The method of claim 1, wherein
the captured content is an audible message received from a user of a phone,
the user's identification and distribution identification are determined, and
the digital media file is received at a portable digital media player of the recipient.

18. A method for providing digital media content, comprising:
providing a first content and a second content;
converting the first content into a first file format, and the second content into a second file format;
automatically transmitting the first content to a first recipient group wherein the first recipient group includes a plurality of recipients using the first file format; and
automatically transmitting the second content to a second recipient group wherein the second recipient group includes a plurality of recipients using the second file format.

19. The method of claim 19, which further includes providing a third content;
converting the third content into a third file format; and
automatically transmitting the third content to both the first recipient group and the second recipient group.

20. A system for automatically sending digital media content, comprising:
a first content and a second content, each received as a first file and a second file;
a first recipient group determined by the first file content and second recipient group determined by the second file content, wherein the first recipient group and the second recipient group include a plurality of recipients; and
a first digital media file converted from the first file and a second digital media file converted from the second file, wherein the first digital media file is automatically transmitted to the first recipient group and the second digital media file is automatically transmitted to the second recipient group.
